(19) United States
(12) Patent Application Publication
(10) Pub. No.: US 2020/0029682 A1
(43) Pub. Date: Jan. 30, 2020

(54) COSMETICS REMOVING TAPE

(71) Applicant: Anisa International, Inc., Atlanta, GA (US)

(72) Inventor: Anisa Telwar Kaicker, Atlanta, GA (US)

(21) Appl. No.: 16/516,779

(22) Filed: Jul. 19, 2019

Related U.S. Application Data
(60) Provisional application No. 62/702,488, filed on Jul. 24, 2018.

(51) Int. Cl. A46B 17/06; C09J 7/30; C09J 7/40; B65H 16/00

(52) U.S. Cl. CPC A46B 17/06; B65H 16/005; C09J 7/40; C09J 7/30

(57) ABSTRACT

Example aspects of a cosmetics removing tape for a cosmetics brush, a tape assembly, and a method for cleaning a cosmetics brush disclosed. The cosmetics removing tape for a cosmetics brush can comprise a sheet defining a front surface and a back surface; and a treatment applied to the front surface, wherein the treatment comprises an adhesive configured to remove residue from the cosmetics brush.

### CROSS-REFERENCE TO RELATED APPLICATIONS

The present application claims priority to U.S. Provisional Application No. 62/702,488, filed Jul. 24, 2018, which is hereby specifically incorporated by reference herein in its entirety.

### TECHNICAL FIELD

This disclosure relates to cosmetic products. More specifically, this disclosure relates to a cosmetics removing tape for removing residue from a cosmetics brush.

### BACKGROUND

Cosmetics brushes are commonly used in apply cosmetics, such as makeup, to a user's skin. Some cosmetics brushes comprises a brush head having fibers, which the cosmetics can adhere to. Much of the cosmetics are removed from the brush head when the cosmetic is applied to the skin; however, some residue from the cosmetics can remain on the brush head. This can reduce the effectiveness of the cosmetics brush, as other cosmetics may not adhere as well to the brush head fibers. Furthermore, the residue can mix with other cosmetics being applied.

Germs and other bacteria can also accumulate in the brush head. The bacteria can be transferred to the user's skin when cosmetics are being applied. Soap and water can be used to remove some of the bacteria and/or cosmetic residue from the brush head; however, this cleaning process can be time consuming. Cleaning with soap and water also results in a wet brush head, which typically cannot be used again until it has dried.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts off the disclosure as an introduction to the following complete and extensive detailed description.

Disclosed is a cosmetics removing tape for a cosmetics brush comprising a sheet defining a front surface and a back surface; and a treatment applied to the front surface, wherein the treatment comprises an adhesive configured to remove residue from the cosmetics brush.

Also disclosed is a tape assembly comprising a cosmetics removing tape comprising a sheet and a treatment applied to the sheet, the treatment configured to remove residue from a cosmetics brush; and a housing configured to store the cosmetics removing tape.

A method for cleaning a cosmetics brush is also disclosed, the method comprising providing a cosmetics removing tape, the cosmetics removing tape comprising a sheet and a treatment applied to the sheet; removing the cosmetics removing tape from a housing; engaging a brush head of the cosmetics brush with the treatment; and moving the brush head against the treatment.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1A shows a perspective view of cosmetics removing tape according to one aspect of the present disclosure.

FIG. 1B is a perspective view of one aspect of a tape assembly comprising a housing for retaining the cosmetics removing tape of FIG. 1A, the housing illustrated in an unfolded configuration.

FIG. 1C is a perspective view of the tape assembly of FIG. 1B wherein the housing of FIG. 1B is in a folded configuration.

FIG. 2A is a perspective view of the housing according to another aspect of the present disclosure.

FIG. 2B is another perspective view of the housing of FIG. 2A.

FIG. 2C is a perspective view of the tape assembly comprising the housing of FIG. 2A and a roll of the cosmetics removing tape, according to another aspect of the present disclosure.

FIG. 3A is a perspective view of the housing according to another aspect of the present disclosure.

FIG. 3B is a perspective view of the tape assembly comprising the housing of FIG. 3A and a roll of cosmetics removing tape according to another aspect of the present disclosure.

FIG. 4A is a perspective view of the tape assembly comprising the housing and a roll of the cosmetics removing tape, in accordance with the present disclosure.

FIG. 4B is a side view of the tape assembly of FIG. 4A.

FIG. 4C is a side view of the tape assembly of FIG. 4A, wherein the housing of FIG. 4A defines an alternative shape, according to another aspect of the present disclosure.

FIG. 5A is an exploded perspective view of the tape assembly comprising the housing and a roll of the cosmetics removing tape, in accordance with another aspect of the present disclosure.

FIG. 5B is a perspective view of the tape assembly of FIG. 5A in an assembled configuration.

FIG. 6A is a top view of the cosmetics removing tape according to another aspect of the present disclosure.

FIG. 6B is a top view of the tape assembly comprising the housing and the cosmetics removing tape of FIG. 6A, according to another example aspect of the present disclosure.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed in the present application is a cosmetics removing tape and associated methods, systems, devices, and various apparatus. Example aspects of the cosmetics removing tape can comprise a sheet of material and a treatment applied to the sheet. The treatment can comprise an adhesive, and in some aspects, can comprise additives that can be cleansing, soothing, or otherwise beneficial to the skin. It would be understood by one of skill in the art that the disclosed cosmetics removing tape is described in but a few exemplary aspects among many. No particular terminology or description should be considered limiting on the disclosure or the scope of any claims issuing therefrom.

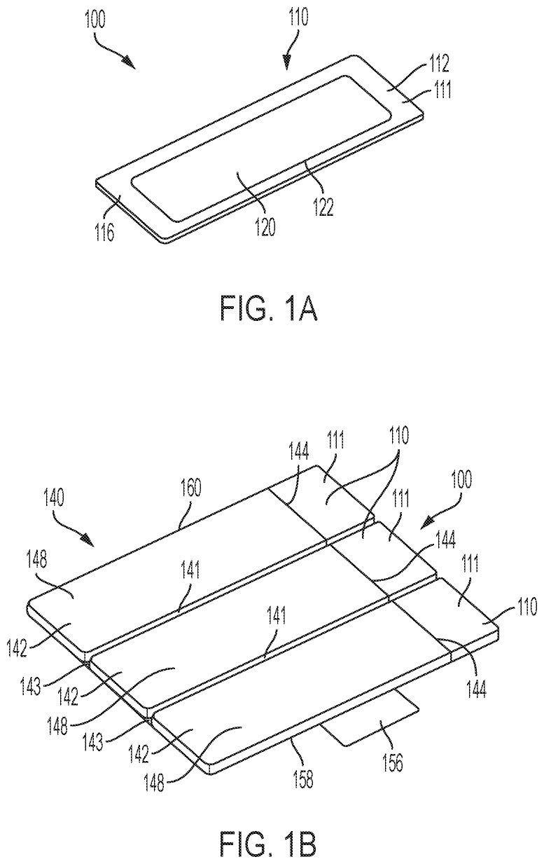

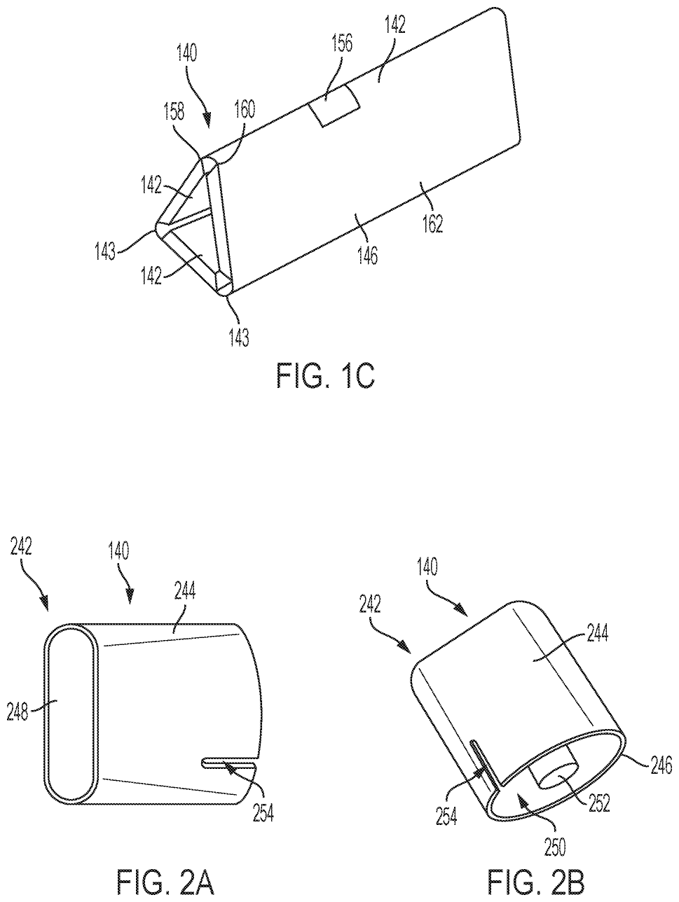

FIG. 1A illustrates a first aspect of a cosmetics removing tape 100 in accordance with the present disclosure. As shown, the cosmetics removing tape 100 can be formed as a tape strip 110 comprising a sheet 112 of material and a treatment 120 applied to the sheet 112. The treatment 120 can comprise a composition of one or more elements. The sheet 112 can comprise a front surface 116 and an opposite back surface (not shown). In example aspects, the sheet 112 can be generally rectangular in shape, as shown, such that the tape strip 110 can be a substantially rectangular tape strip 110. In other aspects, however, the sheet 112 can be any other suitable shape, including, for example, square, triangle, oval, and circle, or any other suitable shape known in the art. Furthermore, example aspects of the sheet 112 can be formed from a paper material. However, other aspects of the sheet 112 can be formed from a plastic material or another suitable material known in the art. In some aspects, the sheet 112 can be formed from a biodegradable material.

According to example aspects, the treatment 120 can be applied to the front surface 116 of the sheet 112, as shown. Optionally, the treatment 120 can be applied to a designated treatment area 122 of the front surface 116, as shown. In some aspects, the designated treatment area 122 can define only a portion of the front surface 116, as illustrated in the present aspect; however, in other aspects, the designated treatment area 122 can define the entire front surface 116. In some aspects, the designated treatment area 122 can be a region of the front surface 116, which in other aspects, the designated treatment area 122 can be defined by a separate material applied to the front surface 116. Some aspects of the sheet 112 can define multiple designated treatments areas 122. In such aspects, the treatments 120 applied to the multiple designated treatment areas 122 can all define the same composition, or can define varying compositions. For example and without limitation, in one aspect, a first treatment area 122 can have a treatment 120 comprising the adhesive only applied thereto, while a second treatment area 122 can have a treatment 120 comprising skin-soothing additives, such as, for example, aloe and oatmeal. The first treatment area 122 comprising the adhesive can be used to remove undesirable residue from a brush head of a cosmetics brush (not shown), while the second treatment area 122 comprising the soothing additives can be used to deposit the soothing additives on the brush head.

According to example aspects, the treatment 120 can comprise an adhesive (not visible). Example aspects of the adhesive can be capable of binding to various cosmetics and other objects or entities, including, but not limited to, bacteria. In some aspects, the treatment 120 can comprise the adhesive only. However, in other aspects, the treatment 120 can define a solution of multiple elements. For example, according to some aspects, the treatment 120 can further comprise one or more additives (not visible) comprising properties that can be anti-bacterial, anti-microbial, cleansing, or soothing to the skin, for example and without limitation. For example, the treatment 120 can comprise one or more additives such as aloe, green tea, collagen, charcoal, vitamin C, vitamin E, alcohol, salicylic acid, parabens, antibacterial ingredients, or any other ingredients having beneficial cosmetics properties, or any combination of such additives.

Example aspects of the tape strips 110 can be provided in varying sizes. For example, in a first aspect, the tape strip 110 can define a width of about 0.5 inches and a length of about 4 inches. In another example aspect, the tape strip 110 can define a width of about 2 inches and a length of about 4 inches. In yet another aspect, the tape strip 110 can define a width of about 3 inches and a length of about 6 inches. In other aspects, the tape strip 110 can define any other suitable size, and the dimensions described herein should not be considered limiting. In some aspects, the size and/or shape of the cosmetics removing tape 100 can correspond to the size and/or shape of the brush head for which the cosmetics removing tape 100 is being used.

As such, an example method of using the cosmetics removing tape 100 can comprise engaging the brush head of a cosmetics brush with the treatment 120 on the cosmetics removing tape 100. The brush head can be moved against the treatment 120 to increase the surface area of the brush head that can contact the treatment 120, in order to remove the maximum amount of residue from the brush head. Moving the brush head against the treatment 120 can also ensure that the brush head contacts the treatment 120 with sufficient force to remove the residue. The brush head, for example, can comprise bristles, a sponge, silicone, or any other suitable brush head configuration known in the art. In some aspects, a user can swipe the brush head across the treatment 120, swirl the brush head on the treatment 120, press the brush head against the treatment 120, or can perform any other suitable motion for engaging the brush head with the treatment 120. Bacteria and cosmetic residue trapped in the brush head can stick to the adhesive, removing the bacteria and cosmetic residue from the brush head. In aspects of the treatment 120 also comprising additional additives, the additives can further aid in cleaning the brush head and/or can be deposited on the brush head to provide beneficial skincare properties to the brush head.

FIG. 1B illustrates an aspect of a housing 140 configured to store the cosmetics removing tape 100, in accordance with the present disclosure. Example aspects of the housing 140 can be configurable in an unfolded configuration, as shown, and a folded configuration (shown in FIG. 1C). The housing 140 can comprise one or more compartments 142. According to an example aspect, such as the aspect depicted herein, the housing 140 can comprises three compartments 142. In other aspects, the housing 140 can comprise more or fewer compartments 142. The compartments 142 can be connected by a bottom panel 146 (shown in FIG. 1C). In some aspects, such as the present aspect, the bottom panel 146 can be formed from a flexible material. As shown, a gap 141 can be formed between each of the compartments 142, and the flexible bottom panel 146 can extend across each of the gaps 141 and can form a hinge 143 between adjacent compartments 142 about which the adjacent compartments 142 can rotate. In other aspects, the bottom panel 146 may not be formed from a flexible material and the hinges 143 can be alternatively formed.

Each compartment 142 can define a void (not shown) defined by a sidewall enclosure 148 of the compartment 142. The void can be configured to receive one or more of the tape strips 110 therein. In some example aspects, the bottom panel 146 can form a back wall (not shown) of the sidewall enclosure 148 of each of the compartments 142. In other aspects, however, the bottom panel 146 does not form a back wall of the sidewall enclosure 148. Furthermore, in some example aspects, the sidewall enclosure 148 can be monolithically formed with the bottom panel 146, and in other aspects, the sidewall enclosure 148 can be formed separately from and attached to the bottom panel 146 by a fastening mechanism (not shown). The fastening mechanism can be for example, sewing, an adhesive such as glue, or any other suitable fastener known in the art.

Each compartment 142 can further define an opening 144, which can allow access to the void. The void of each compartment 142 can be sized and shaped to house at least one of the tape strips 110 of the cosmetics removing tape 100. As shown, the tape strips 110 can be inserted into the corresponding void through the corresponding opening 144 of the compartment 142. According to example aspects, an end portion 111 of the tape strip 110 can extend through the opening 144 and out of the compartment 142, such that the end portion 111 can be easily accessed by a user. To remove one of the tape strips 110 from the housing 140, the user can grip the end portion 111 of the tape strip 110 and pull the tape strip 110 out of the compartment 142 for use.

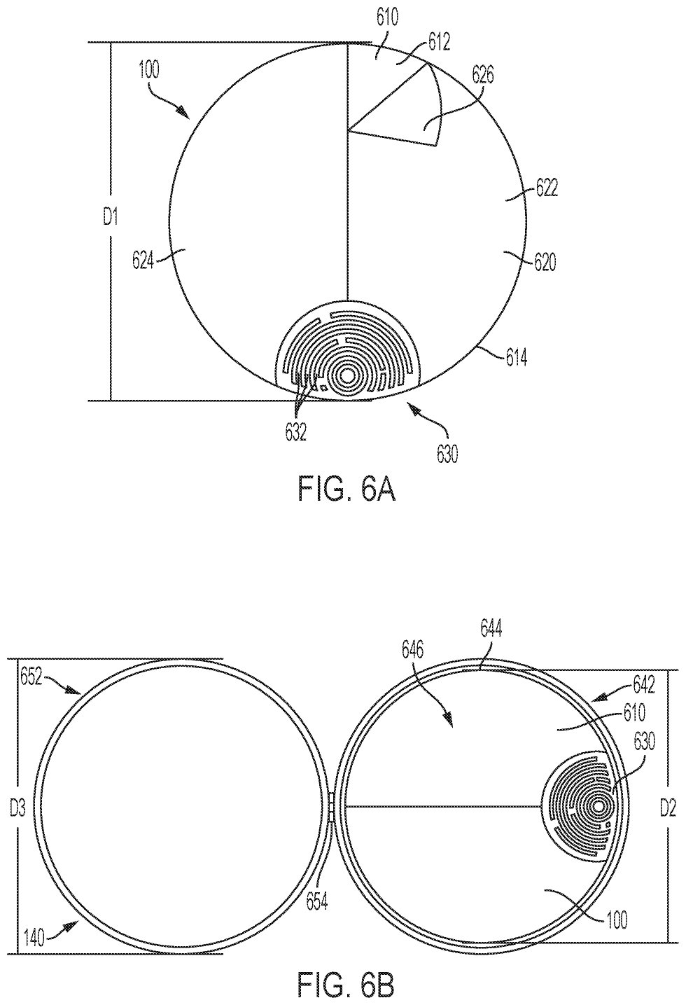

In some aspects, the cosmetics removing tape 100 can comprise a wrapping (not shown) or a backing 620 (shown in FIG. 6A), which can be configured to protect the sheet 112 and/or treatment 120 from external elements, such as, for example, dust, moisture, and bacteria. The backing 620 or wrapper can be removed from the tape strip 110 before use of the tape strip 110, as described in further detail below with reference to FIG. 6A.

According to example aspects, as shown, a closing fastener 156 can extend from a first side 158 of the housing 140. Example aspects of the housing 140 can also comprise a mating closing fastener (not shown) positioned at an opposing second side 160 of the housing 140. For example, in some aspects, the mating closing fastener can be positioned on a bottom surface 162 (shown in FIG. 1C) of the flexible bottom panel 146. In example aspects, the closure fastener 156, and the mating closure fastener if a mating closure fastener is present, can be hook and loop fasteners, magnets, snaps, zippers, adhesives, or any other suitable fastener known in the art.

FIG. 1C illustrates the housing 140 in the folded configuration. As shown, the compartments 142 can be folded about the hinges 143 formed therebetween, such that the first side 158 of the housing 140 can be disposed adjacent to the second end 160 of the housing 140. The housing 140 can be retained in the folded configuration by coupling the closing fastener 156 with the mating closing fastener (not shown). In the depicted aspect, the housing 140 can define a substantially triangular cross sectional shape in the folded configuration. However, in other aspects, the housing 140 can form any other suitable cross sectional shape, such as a circle, oval, rectangle, or pentagon, for example and without limitation.

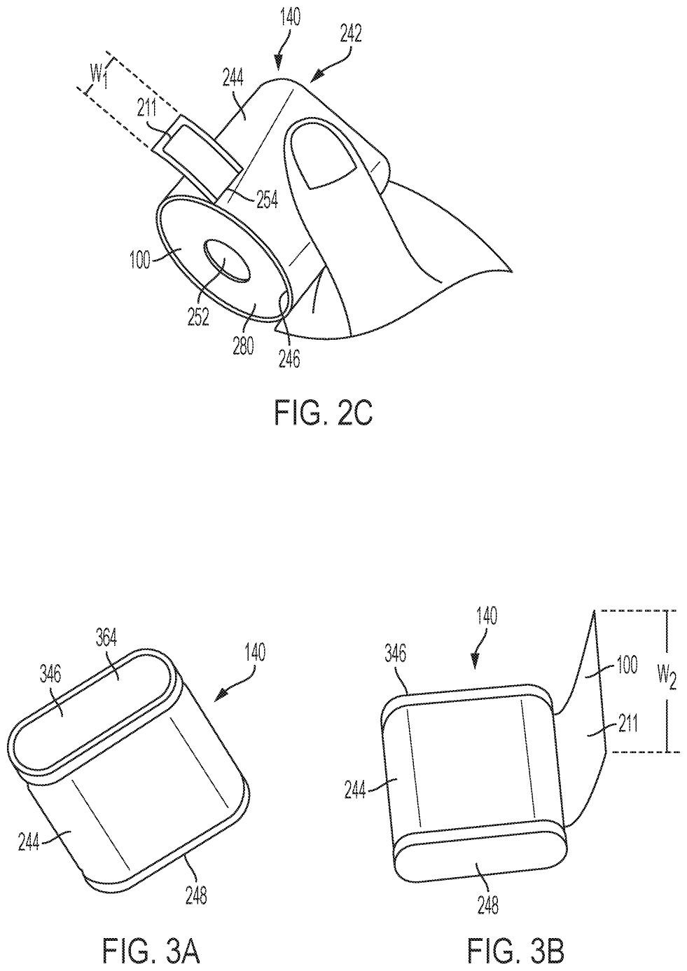

FIG. 2A-2C illustrate another aspect of the housing 140 in accordance with the present disclosure. Referring to FIG. 2A, in the present aspect, the housing 140 can comprise a casing 242 defining a sidewall enclosure 244, an open first end 246 (shown in FIG. 2B), and a closed second end 248. The sidewall enclosure 244 and closed second end 248 can define an interior cavity 250. Example aspects of the housing 140 can define a pill- or capsule-shaped cross section, as illustrated. In other aspects, the cross sectional shape of the housing 140 can be circle, rectangle, oval, triangle, or any other suitable shape. According to example aspects, as shown, an aperture, such as a slit 254, can be formed in the casing 242. In example aspects, the slit 254 can be formed in the sidewall enclosure 244 at the open first end 246 of the housing 140. In other aspects, the slit 254 can be formed elsewhere in the sidewall enclosure 244 or in the closed second end 248 of housing 140. Referring to FIG. 2B, the housing 140 can further comprising a post 252 fixedly mounted to the closed second end 248 of the casing 242 and extending generally through a center of the interior cavity 250, as shown.

As shown in FIG. 2C, in the depicted aspect, a roll 280 of the cosmetics removing tape 100 can be provided. The rolled 280 can define a width W₁, as shown. According to example aspects, the roll 280 can be inserted into the interior cavity 250 through the open first end 246 of the casing 242 and can be mounted on the post 252. In example aspects, the roll 280 can be configured to rotate relative to the fixed post 252. As shown, an end 211 of the roll 280 of cosmetics removing tape 100 can extend through the slit 254, as illustrated. To pull an additional length of the cosmetics removing tape 100 through the slit 254, the end 211 of the roll 280 can be gripped by a user and pulled away from the housing 140.

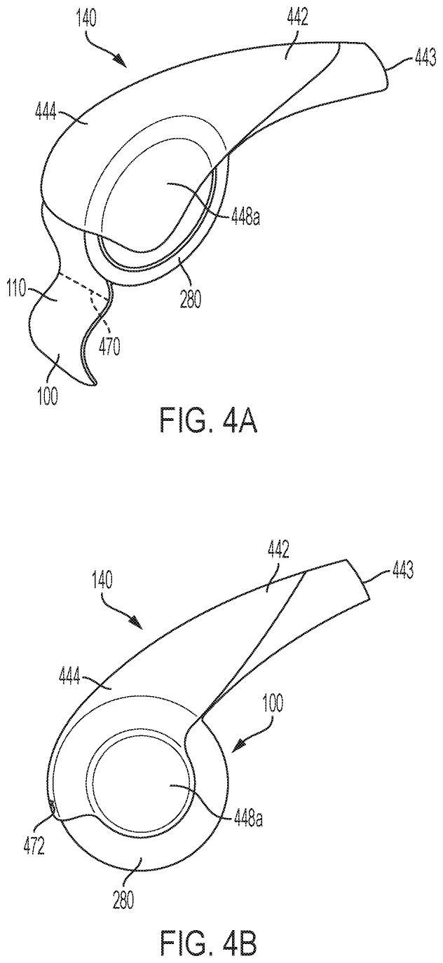

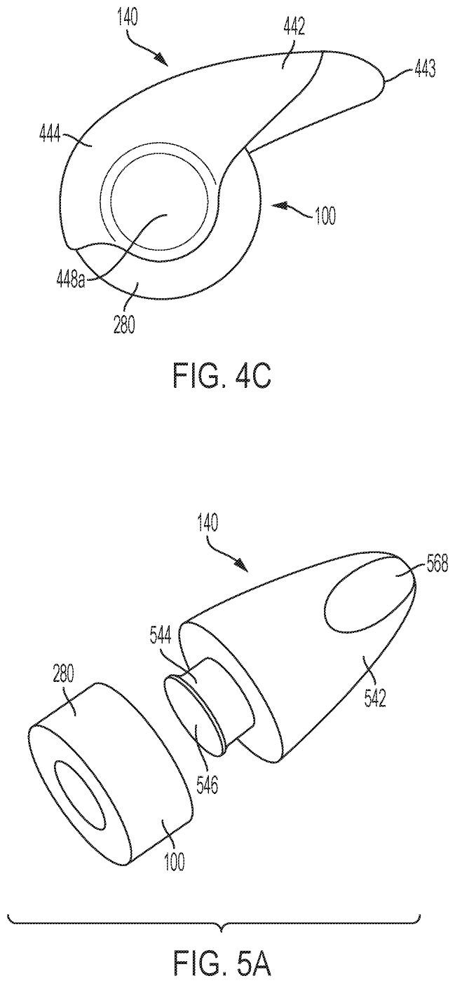

In example aspects, the roll 280 of cosmetics removing tape 100 can be sectioned into the separate tape strips 110 (shown in FIG. 1). For example, in one aspect, the roll 280 can be sectioned into the tape strips 110 by perforations 470 (shown in FIG. 4A) formed on the roll 280 of the cosmetics removing tape 100. A user can detach a pre-sectioned tape strip 110 from the roll 280 by tearing the cosmetics removing tape 100 at the perforations 470. In other aspects, the roll 280 of cosmetics removing tape 100 can be sectioned into the tape strips 110 by creasing or by any other suitable sectioning methods known in the art. In still other aspects, the roll 280 of cosmetics removing tape 100 can be un-sectioned. For example, a user can tear a tape strip 110 away from the roll 280 by pressing the cosmetics removing tape 100 on a blade (not shown). In example aspects, the blade can be a serrated blade. In such an aspect, a user can pull a desired length of the cosmetics removing tape 100 from the housing 140 and can cut away a tape strip 110 of the desired length. In still other aspects, the tape strip 110 can be torn from the roll 280 manually or by any other suitable methods known in the art.

FIGS. 3A-3B illustrate another aspect of a housing 140 configured to store and dispensing the cosmetics removing tape 100, in accordance with the present disclosure. As shown, the housing 140 can be substantially similar to the housing 140 of FIGS. 2A-2C. However, in the current aspect, the housing 140 can comprise a closed first end 346, as opposed to the open first end 246 shown in FIG. 2B. The sidewall enclosure 244 can extend between the closed first end 346 and the closed second end 248. According to example aspects, one or both of the closed first and second ends 346,248 can comprise a removable cap 364. The cap 364 can be selectively removed to allow access to the interior cavity 250 of the housing 140 for inserting or replacing the roll 280 (shown in FIG. 2C) of cosmetics removing tape 100. Further, in the current aspect, as shown in FIG. 3B, the cosmetics removing tape 100 can define a greater width W₂ than the width W₁ of the cosmetics removing tape 100 shown in FIG. 2C. In other aspects, the cosmetics removing tape 100 can define a width that can be less than, greater than, or in between the widths W₁ and W₂.

FIGS. 4A-4B illustrate yet another aspect of a housing 140 in accordance with the present disclosure. The housing 140 is illustrated as transparent in FIG. 4A-4B for visibility of interior details. According to example aspects, the housing 140 can generally comprise a handle 442 and a shield 444. In the present aspect, as shown, the handle 442 and the shield 444 can be monolithically formed with one another. However, in other aspects, the handle 442 and shield 444 can be separately formed. Example aspects of the housing 140 can further comprise an axle (not shown) extending between opposing sides 448a,b (side 448b not shown) of the shield 444. For example, the axle can be similar to the post 252 illustrated in FIG. 2B and can be fixedly mounted to each of the opposing sides 448a,b. In example aspects, the roll 280 of the cosmetics removing tape 100 can be received on the axle and can rotate with respect to the axle. The shield 444 can be configured to cover a portion of the roll 280, as shown.

As described above, and as shown in FIG. 4A, in some aspects, the roll 280 can be sectioned by perforations 470 into tape strips 110 of a predetermined length. In other aspects, a user can select a desired length of the cosmetic removing tape 100, and can tear or cut off a tape strip 110 of the desired length. For example, referring to FIG. 4B, example aspects of the housing 140 can include a blade 472 to facilitate tearing a tape strip 110 from the roll 280. In some aspects, the blade 472 can extend from the shield 444, as shown, and the shield 444 can cover the blade 472 to prevent a user from accidentally touching the blade 472. According to example aspects, the handle 442 can be gripped by a user during use of the housing 140. In the depicted aspect, an end 443 of the handle 442 distal to the shield 444 can be substantially squared, as illustrated in the aspect of FIGS. 4A-4B. In other aspects, such as the aspect depicted in FIG. 4C, the end 443 of the handle 442 can be rounded.

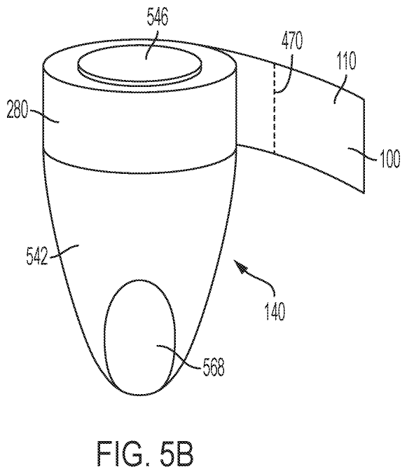

FIGS. 5A-5B illustrate still another aspect of a housing 140 in accordance with the present disclosure. Referring to FIG. 5A, as shown, example aspects of the housing 140 can comprise a handle 542 and a post 544 fixedly coupled to and extending from the handle 542. Some aspects of the housing can further comprise a cap 546 coupled to the post 544 distal from the handle 542. The roll 280 of the cosmetics removing tape 100 can be received on the post 544 and can rotate relative to the fixed post 544. According to example aspects, the cap 546 can be removable from the post 544 to facilitate mounting the roll 280 of cosmetics removing tape 100 onto the post 544. However, in other aspects, the cap 546 can be fixedly coupled to the post 544, and the roll 280 can be mounted on the post 544 by pushing the roll 280 past the cap 546 with a sufficient force. Moreover, as shown, in some aspects, the handle 542 can define one or more finger indentations 568 configured to improve comfort and grip for a user during use. Referring to FIG. 5B, in the present aspect, as shown, perforations 470 can section the roll 280 of cosmetics removing tape 100 into tape strips 110 of a predetermined length and can facilitate a user tearing an individual tape strip 110 away from the roll 280.

FIG. 6A illustrates the cosmetics removing tape 100 according to another aspect of the present disclosure. The cosmetics removing tape 100 can comprise a tape pad 610 comprising the sheet 112 and the treatment 120. The sheet 112 can define the front surface 116 and the back surface (not shown). In the present aspect, the tape pad 610 can be a substantially circular tape pad 610, which can generally define a diameter D₁, as shown. In other aspects, the tape pad 610 can define any other suitable shape, including but not limited to, oval, rectangle, triangle, and the like. The treatment 120 can comprise the adhesive and can be applied to the front surface 116 of the sheet 112, such that the front surface 116 can define a sticky side 612 and the back surface can define a non-sticky side (not shown). According to example aspects, a backing 620 can be removably attached to the sticky side 612 to protect the treatment 120 until a user removes the backing 620 in preparation for using the cosmetics removing tape 100. In other example aspects, the cosmetics removing tape 100 can comprise a wrapper (not shown) that can fully encompass tape pad 610, and which can be removed when a user is ready to use the cosmetics removing tape 100.

In some aspects, the backing 620 can be a singular piece. In the present aspect, however, as shown, the backing 620 can comprise a first backing piece 622 and a second backing piece 624. In the present example, each of the first and second backing pieces 622,624 can define a generally semi-circular shape. However, in other aspects, the first and second backing pieces 622, 624 can define any other suitable shape. In still other aspects, the backing 620 can comprise more or fewer backing pieces. To remove the backing 620, as shown, a corner 626 of the first backing 622 can be engaged by a user and pulled away from the tape pad 610 to uncover the corresponding portion of the sticky side 612. The second backing 624 can then be removed from the tape pad 610 in a similar manner to fully uncover the sticky side 612 and to reveal the treatment 120. In other aspects, the second backing 624 can be removed first, followed by the first backing 622.

According to some example aspects of the cosmetics removing tape 100, the tape pad 610 can include a gripping area 630, which can allow a user to hold the cosmetics removing tape 100 without touching the treatment 120. Example aspects of the gripping area 630 can also serve as a marker to indicate where a user should grip the tape pad 610 and/or to provide a non-slip surface for an improved grip on the tape pad 610. In the present aspect, the gripping area 630 can define a plurality of ridges 632 extending from the front surface 116 (e.g., the sticky side 612) of the tape pad 610. Example aspects of the gripping area 630 can be positioned proximate to an outer edge 614 of the sheet 112 of the cosmetics removing tape 100, as shown. In some aspects, the portion of the front surface 116 covered by the gripping area 630 may be treated by the treatment, and the ridges 632 can extend away from the front surface 116, such that a user engaging the gripping area 630 will not contact the treatment. In other aspects, the portion of the front surface 116 covered by the gripping area 630 may not be treated by the treatment, and the ridges 632 can simply serve as an indicator of where to grip the tape pad 610 and/or can provide a non-slip area for gripping the tape pad 610. According to other aspects, the gripping area 630 may not comprise the ridges 632 and can instead define a continuous surface or can define any other suitable pattern. In some aspects, the gripping area 630 can simply be a portion of the front surface 116 that is not treated by the treatment.

According to various example aspects, a user can hold the cosmetics removing tape 100 between at least two fingers of the same hand. For example, a first finger (e.g., a thumb) can engage the gripping area 630 on the front surface 116 of the sheet 112, and a second finger (e.g., a pointer finger) can engage the back surface of the sheet 112, such that the cosmetics removing tape 100 can be held between the first and second fingers. As described above, the gripping area 630 can prevent the user from contacting the treatment 120 applied to the front surface 116. The user can then proceed to remove the backing 620 from the front surface 116, if such a backing 620 is present, to uncover the sticky side 612 and reveal the treatment 120. With the user's other hand, the user can hold a cosmetics brush (not shown) and can engage the brush head of the cosmetics brush with the treatment 120. Once engaged, the user can move the brush head against the treatment 120—for example, the user can press, swirl, swipe, or otherwise move the brush head against the treatment 120. Residue (for example, bacteria, cosmetics, etc.) trapped in the brush head can stick to the adhesive in the treatment 120, such that the residue can be removed from the brush head. As described above, moving the brush head against the treatment 120 can increase the surface area of the brush head that can contact the treatment 120 and can ensure that the brush head contacts the treatment 120 with sufficient force. Furthermore, in some aspects, additives in the treatment 120 comprising anti-bacterial and/or anti-microbial properties can be deposited on the brush head and can aid in cleaning the brush head and/or the user's skin, and any additives in the treatment 120 comprising skin-soothing properties can be deposited on the brush head and can soothe a user's skin during future use of the cosmetics brush.

FIG. 6B illustrates the housing 140 in accordance with another aspect of the present disclosure. As shown, the housing 140 can define a bottom compartment 642 configured to receive the cosmetics removing tape 100. For example, the bottom compartment 642 can define a recess 646 (recess 646 extending into the page in the depicted aspect) configured to receive a stack of the circular tape pads 610 therein. The bottom compartment 642 can further define an opening 644 through which the tape pads 610 can be inserted into the recess 646 and removed for use by a user. Example aspects of the opening 644 can define a diameter D₂ that can be about equal to or greater than the diameter D₁ of the tape pads 610. In some aspects, the housing 140 can also define a lid 652 for selectively covering and uncovering the opening 644 of the bottom compartment 642. In the present aspect, the lid 652 can be hingedly coupled to the bottom compartment 642 by a hinge 654, as shown. The lid 652 can rotate about the hinge 654 between an open position, as shown, wherein the opening 644 is uncovered and a user can access the tape pads 610, and a closed position, wherein the opening 644 is covered. In other aspects, the lid 652 can be pivotably coupled to the bottom compartment 642 by a pivot pin (not shown), can be slidably coupled to the bottom compartment 642, or can be otherwise movably coupled to the bottom compartment 642 for movement between the open and closed positions. According to example aspects, the lid can 652 define a diameter D₃ that can be about equal to or greater than the diameter D₂ of the opening 644, such that the lid 652 can fully cover the opening 644 in the closed position.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A cosmetics removing tape for a cosmetics brush, the cosmetics removing tape comprising:
a sheet defining a front surface and a back surface; and
a treatment applied to the front surface, wherein the treatment comprises an adhesive configured to remove residue from the cosmetics brush.

2. The cosmetics removing tape for a cosmetics brush of claim 1, further comprising a backing removably coupled to the front surface and configured to cover the treatment.

3. The cosmetics removing tape for a cosmetics brush of claim 1, wherein;
the treatment further comprises an additive providing at least one of anti-bacterial and anti-microbial properties; and
the additive is selected from one of alcohol, green tea, salicylic acid, and parabens.

4. The cosmetics removing tape for a cosmetics brush of claim 1, wherein;
the treatment further comprises an additive providing skin-soothing properties; and
the additive is selected from one of aloe, collagen, charcoal, vitamin C, and vitamin E.

5. The cosmetics removing tape for a cosmetics brush of claim 1, wherein the sheet is formed as one of a substantially rectangular tape strip and a substantially circular tape pad.

6. The cosmetics removing tape for a cosmetics brush of claim 1, wherein;
the treatment is applied to a designated treatment area of the front surface; and
the designated treatment area defines only a portion of the front surface.

7. The cosmetics removing tape for a cosmetics brush of claim 1, wherein the cosmetics removing tape is formed as a roll.

8. The cosmetics removing tape for a cosmetics brush of claim 7, wherein the roll is sectioned into a plurality of tape strips.

9. The cosmetics removing tape for a cosmetics brush of claim 1, further comprising a gripping area positioned proximate to an outer edge of the sheet.

10. The cosmetics removing tape for a cosmetics brush of claim 9, wherein the gripping area defines a plurality of ridges extending from the front surface.

11. A tape assembly comprising:
a cosmetics removing tape comprising a sheet and a treatment applied to the sheet, the treatment configured to remove residue from a cosmetics brush; and
a housing sized to store the cosmetics removing tape.

12. The tape assembly of claim 11, wherein the housing comprises a bottom compartment and a lid.

13. The tape assembly of claim 12, wherein the bottom compartment defines a recess configured to receive the cosmetics removing tape therein and an opening through which the cosmetics removing tape can be inserted into and removed from the recess.

14. The tape assembly of claim 13, wherein the housing further comprises a lid movable between a closed position, wherein the opening is covered by the lid, and an open position, wherein the opening is uncovered.

15. The tape assembly of claim 11, wherein;
the cosmetics removing tape is formed as a roll;
the housing defines a post; and
the roll is configured to rotate on the post.

16. The tape assembly of claim 15, wherein an end of the roll is configured to extend through an aperture formed in the housing.

17. The tape assembly of claim 11, wherein;
the housing defines a plurality of compartments joined with a bottom panel; and
the housing is configured to be arranged in an unfolded configuration and a folded configuration.

18. A method for cleaning a cosmetics brush comprising:
providing a cosmetics removing tape, the cosmetics removing tape comprising a sheet and a treatment applied to the sheet;
removing the cosmetics removing tape from a housing;
engaging a brush head of the cosmetics brush with the treatment; and
moving the brush head against the treatment.

19. The method of claim 18, further comprising removing a backing from the treatment before engaging the brush head of the cosmetics brush with the treatment.

20. The method of claim 18, further comprising engaging a gripping area of the cosmetics removing tape.
